(19) United States
(12) Patent Application Publication
(10) Pub. No.: US 2008/0012996 A1
(43) Pub. Date: Jan. 17, 2008

(54) Brand-shaped image-display advertising apparatus

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314, US

(21) Appl. No.: 11/798,359

(22) Filed: May 14, 2007

(30) Foreign Application Priority Data
Jul. 13, 2006 (KR) 10-2006-0066671
Jan. 23, 2007 (KR) 10-2007-0006920

(51) Int. Cl. H04N 9/31

(52) U.S. Cl. 348/744

(57) ABSTRACT

Disclosed is a brand-shaped image-display advertising apparatus having the shape of a selected brand. The advertising apparatus includes a brand-shaped board that is made of an opaque metal material containing pigments or a transparent plastic or glass material containing dyes, and an optical source device provided at a rear side of the brand-shaped board, the optical source device including an imaging screen using a PDP, LCD, or LED, and a projector. If the projector projects an image on the imaging screen, the brand-shaped board displays the shape of the brand and the image simultaneously. Conversely, when no image is projected, the brand-shaped board displays the colors of the dyes. Accordingly, the brand-shaped image-display advertising apparatus serve to display moving images and also, serve as a brand billboard.

### BACKGROUND OF THE INVENTION

1. Field of the Invention

The present invention relates to a brand-shaped image-display advertising apparatus, which employs a billboard taking the form of a brand and displays a moving image on the brand-shaped billboard, thereby achieving an improvement in the visual effect of a so-called “brand billboard”.

More particularly, the present invention relates to a brand-shaped image-display advertising apparatus for use as a brand billboard, which can serve as a brand-shaped image-display apparatus if an image is projected on a brand-shaped structure and also, can show an original color and shape of a brand if no image is projected thereon.

2. Description of the Related Art

The term “Brand” is represented by names, symbolic items, designs, lettered symbols, and combinations thereof suitable for identification of company's products and services and differentiation of products and for endowing customers with distinctive values.

Recently, according to a tendency of regarding the value of a brand very highly, all advertisements give undue value to the brand, and a brand-shaped structure is increasingly used alone instead of a complicated billboard.

In the case of conventional simple billboard apparatuses, they have an unchangeable printed pattern and their function is limited to show their shape. Accordingly, the conventional billboard apparatuses are inefficient to attract the customer's eyes and fail to be differentiated, thus resulting in a meager advertisement effect.

### SUMMARY OF THE INVENTION

Therefore, the present invention has been made in view of the above problems, and it is an object of the present invention to provide a brand-shaped image-display advertising apparatus in which an image, for example, a moving image, is displayed on a brand-shaped structure, in the form of a word, sign, symbol, design, the product's shape, etc., to make the brand-shaped structure look better, thereby achieving an improvement in the visual effect of the advertising apparatus and the advertising effect of a brand.

It is another object of the present invention to provide a brand-shaped image-display advertising apparatus which can be selectively converted into or compatibly used as both a brand-shaped image-display apparatus when an image is displayed thereon and a brand billboard for showing an original shape and color of a brand when no image is displayed thereon, in consideration of environmental conditions of the apparatus, such as in the daytime or night, in light or dark places, and indoor and outdoor.

It is yet another object of the present invention to provide a brand-shaped image-display advertising apparatus in which a variety of images, having various colors and patterns related to a brand, are displayed on a brand-shaped structure installed at a window glass, thereby being usable not only as a brand-shaped image-display apparatus for displaying vivid moving images, but also as a brand advertising apparatus showing an original color and shape of the brand when no image is displayed thereon.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partial front view illustrating an installation example of the present invention;

FIG. 2 is a diagrammatic explanatory view illustrating a combination of a brand-shaped image-display billboard and a projector according to a first embodiment of the present invention;

FIG. 3 is a diagrammatic explanatory view illustrating a combination of a brand-shaped image-display billboard and a projector according to a second embodiment of the present invention;

FIG. 4A is a side sectional view illustrating a combination of a transparent image-display board and a projector;

FIG. 4B is a side sectional view illustrating a combination of an opaque colored board and a projector;

FIG. 4C is a side sectional view of the transparent image-display board;

FIG. 4D is a side sectional view of the opaque colored board;

FIG. 5A is a diagrammatic explanatory view illustrating a brand-shaped transparent board according to the present invention;

FIG. 5B is a diagrammatic explanatory view illustrating a brand-shaped transparent board having a lettered figure;

FIG. 5C is a diagrammatic explanatory view illustrating a brand-shaped opaque colored board having a lettered figure;

FIG. 6A is a diagrammatic explanatory view illustrating a combination of a brand-shaped transparent board and a surrounding opaque colored board;

FIG. 6B is a diagrammatic explanation view illustrating a combination of a brand-shaped opaque colored board and a surrounding transparent board;

FIG. 7 is a side sectional view illustrating a both-sided image-display advertising apparatus according to the present invention;

FIG. 8 is a perspective view illustrating a wall-rack type use example of the present invention; and

FIG. 9 is a perspective view illustrating a desktop type use example of the present invention.

### DETAILED DESCRIPTION OF THE PREFERRED EMBODIMENTS

Reference will now be made in detail to the preferred embodiments of the present invention, examples of which are illustrated in the accompanying drawings.

Prior to describing the preferred embodiments, first, the basic principal of the present invention will be described.

As well known, coloring substances include a pigment and a dye.

The pigment may be classified into an inorganic pigment and an organic pigment, and have no range in color sensitivity and a high light masking property.

Main examples of the pigment include Tio2, Hgs, CuCo3, Cu(OH)3, As2S2, and so on.

Meanwhile, there are various kinds of dyes, for example, a synthetic dye, vegetable dye, animal dye, mineral dye, chemical dye, and so on. These various kinds of dyes are selectively used according to their color sensitivity, transparency of images, and characteristics of selected materials to be colored.

The dyes have a feature of transmitting light while maintaining their color.

The present invention is characterized in that a transparent dye and an opaque pigment are appropriately mixed in a brand-shaped structure or a mixture of the dye and the pigment is selectively used in specific positions of the brand-shaped structure, and an optical source device is provided at the rear side of the brand-shaped structure, to constitute an image-display system.

Now, the configuration and operation of a brand-shaped image-display advertising apparatus according to the present invention will be described in detail.

The image-display advertising apparatus of the present invention may include a brand-shaped board 100 taking the form of a predetermined brand, or may include a brand billboard 101 containing the brand-shaped board 100 at a predetermined position thereof.

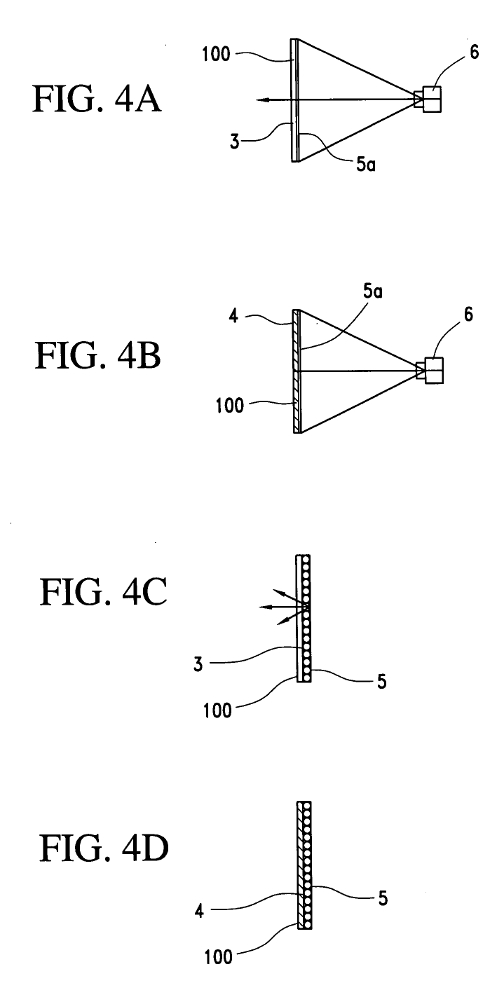

Referring to FIGS. 4A and 4C, the brand-shaped board 100 may be formed by use of a transparent image-display board 3. The transparent image-display board 3 is made of a transparent material, such as plastic and glass, and a light-transmittable transparent dye may be mixed in the transparent image-display board 3, or may be printed on a surface of the transparent image-display board 3 to have a desired pattern.

On the other hand, in the case where the brand-shaped board 100 constitutes a part of the brand billboard 101, the brand-shaped board 100 may be formed by use of an opaque colored board 4 if necessary.

The transparent image-display board 3 containing the dye therein is adapted to display a variety of images stored in a computer, digital video disk (DVD), etc. under operation of an optical source device 5 that is provided at a rear surface of the transparent image-display board 3.

To fulfill the above described function, the image must have a predetermined brightness.

That is to say, if the image has no brightness, the image cannot be transmitted onto the transparent image-display board 3.

Accordingly, to obtain an image-display apparatus having a light source, the optical source device 5 may be formed of an electric display board, monitor, or the like using a plasma display panel (PDP), liquid crystal display (LCD), or light emitting diode (LED) that are usable to display images stored in a computer, DVD, etc. Alternatively, as shown in FIGS. 4A and 4B, the optical source device 5 may be substituted by a combination of a projector 6 and an imaging screen 5a.

The image-display advertising apparatus of the present invention is previously provided with a variety of images stored in a computer, DVD, CD, and so on.

Meanwhile, Referring to FIGS. 4B and 4D, the brand-shaped board 100 may be formed by use of the opaque colored board 4. The opaque colored board 4 is made of a variety of materials, such as metal and plastic, so long as letters, symbols, and patterns are allowed to be formed thereon. Also, a pigment may be mixed in the opaque colored board 4, or may be printed on a surface of the opaque colored board 4. Alternatively, the surface of the opaque colored board 4 may represent a metallic material surface itself.

Specifically, the opaque colored board 4 may be formed by mixing a pigment in a plastic or glass material, by applying a pigment to the surface of the opaque colored board 4 by a screen printing method, etc., or by processing an aluminum or metal material to have a desired shape.

### First Embodiment

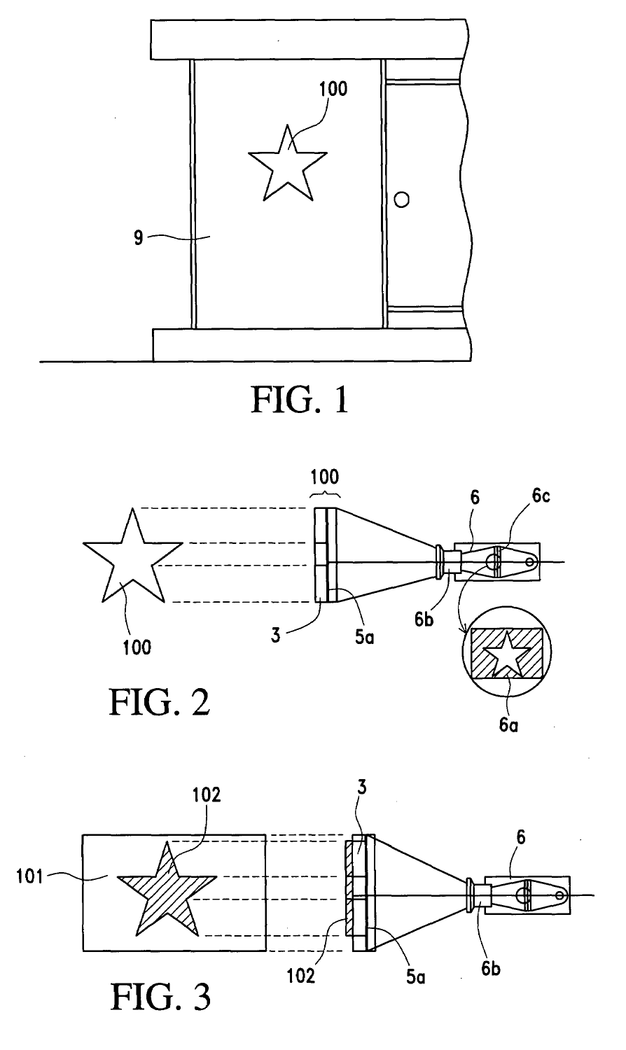

FIG. 1 illustrates a usage of the brand-shaped board 100 installed to a window 9 of a shop.

As shown in FIG. 2, the brand-shaped board 100 includes the brand-shaped transparent image-display board 3, the imaging screen 5a provided at the rear surface of the transparent image-display board 3, and the projector 6 located behind the imaging screen 5a.

Although there are a variety of shapes of brands, an image projected from the projector 6 has a rectangular shape having an aspect ratio of 4:3 or 16:9.

Accordingly, if the rectangular image from the projector 6 is directly projected on the brand-shaped board 3, an extra portion of the projected image beyond the brand-shaped board 3 is directly projected on the customer's eyes, and there is an urgent need for preventing the abnormal image projection.

As a solution of the above problem, as shown in FIG. 2, an image intercepting film 6a is provided at a front surface of an imaging board 6c that is located behind a projection lens 6b of the projector 6. The image intercepting film 6a includes a transparent portion having a shape corresponding to that of the brand-shaped board 3 and the remaining opaque portion, to allow only a brand-shaped portion of the image to be transmitted therethrough while intercepting the remaining portion of the image.

By providing the image intercepting film 6a in the projector 6, the image, which will be displayed on the brand-shaped transparent board 3 by the projection lens 6b, is projected on the imaging screen 5a provided at the rear surface of the brand-shaped transparent board 3 to have a shape corresponding to that of the brand-shaped transparent board 3 regardless of the original shape of the image. Accordingly, there is no risk in that the image exceeds the brand-shaped board 100.

In this case, the brand-shaped board 100, which has the same shape as that of the image intercepting film 6a, is usable as a screen.

### Second Embodiment

Referring to FIG. 3, it will be appreciated that the same effect as that of the first embodiment can be accomplished even when the shape of an image is edited to have a predetermined brand shape.

As shown in FIG. 3, the image-display advertising apparatus according to the present embodiment includes the brand billboard 101 that is made of the transparent image-display board 3, and a brand-shaped board 102 that is made of an opaque brand-shaped board 101a. In the present embodiment using no separate image intercepting film 6a, if an image is projected from the projector 6 onto the brand billboard 101, the opaque brand-shaped board 101a reveals its brand shape, and the image is projected only on the transparent image-display board 3.

In the above described configuration, for example, the opaque brand-shaped board 100a may be made of a variety of materials, such as metal and glass, and have a shape corresponding to the shape of an advertising product, and the transparent board 3 around the opaque brand-shaped board 101a may display an image related to the product.

### Third Embodiment

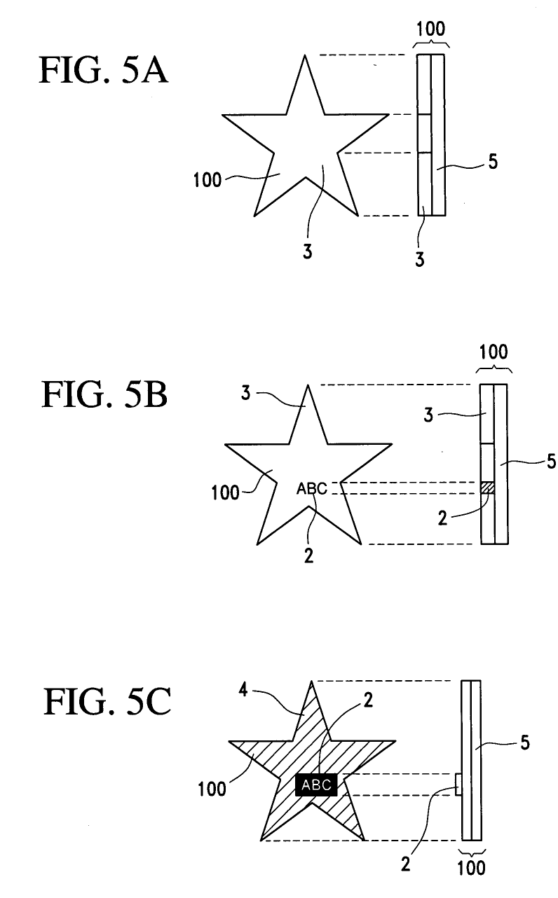

FIG. 5A illustrates an example of the brand-shaped board 100 having the shape of a star.

It will be appreciated that the shape of the brand-shaped board 100 is not limited to the above mentioned shape, and may be freely selected from among various letters, signs, symbols, designs, product's shapes, and their combinations.

The brand-shaped board 100 is made of the transparent image-display board 3 having the color of a dye contained therein, and the optical source device 5 is provided at the rear surface of the transparent image-display board 3.

With the above described configuration, if an image is inputted into the optical source device 5, the light of the image is transmitted through the transparent image-display board 3 containing the light-transmittable dye, whereby the image is displayed on the brand-shaped board 100 to have a shape corresponding to that of the brand-shaped board 100.

If the input of the image is intercepted, the dye contained in the brand-shaped board 100 shows its original color upon receiving light from the outside. In this case, the brand-shaped board 100 serves as a brand billboard.

For example, if a variety of images, such as twinkling golden-color waves, is displayed on the brand-shaped board by operation of the optical source device 5 in a state wherein the brand-shaped board 100 is installed at the glass window 9 as shown in FIG. 1, the image is transmitted through the transparent image-display board 3, to allow the brand-shaped board 100 to represent a golden color.

On the other hand, if the optical source device 5 is not operated, the brand-shaped board 100 serves as a brand billboard showing the color of the dye contained in the transparent image-display board 3.

In the same principle, if the optical source device 5 produces a fireworks display, the brand-shaped board 100 shows the fireworks display efficient to attract the customer's eyes. Attracting the customer's eyes has the effect of impressing the brand shape to customers.

In this way, the brand-shaped board 100 showing a variety of moving images can be constructed.

### Fourth Embodiment

Referring to FIG. 5B, a figure board 2, which takes the form of a brand name, sign, symbol, product's shape, etc., may be provided at a portion of the brand-shaped board 100.

In the present embodiment, the figure board 2 is made of the opaque colored board 4, and the brand-shaped board 100 is made of the transparent image-display board 3. Also, if the optical source device 5 inputs a variety of moving images into the brand-shaped board 100, the brand-shaped board 100 is able to display the images thereon.

In this case, the figure board 2 displays its figure, such as symbols, letters, or the like, having the color of the opaque colored board 4, and the brand-shaped board 100 displays the variety of images. This has the effect of efficiently showing both the brand shape and the shape of the figure board 2 simultaneously.

### Fifth Embodiment

Referring to FIG. 5C, although the present embodiment is similar to the above fourth embodiment in view of that the figure board 2 is provided at a portion of the brand-shaped board 100, in the present embodiment, the figure board 2 is made of the transparent image-display board 3, and the brand-shaped board 100 is made of the opaque colored board 4. Also, the optical source device 5 is coupled to the rear surface of the brand-shaped board 100.

With the above described configuration, the brand-shaped board 100 displays an original color of the brand, and the figure board 2 containing letters, etc. is able to display a moving image under operation of the optical source device 5.

For example, the overall brand-shaped board 100 is made of aluminum, or other metals plated with a golden material, and the figure board 2 made of the transparent image-display board 3 is provided at a portion of the brand-shaped board 100 to transmit the image produced by the optical source device 5 provided at the rear surface of the brand-shaped board 100.

The present embodiment has the effect of allowing the figure board 2 to show a vivid image at a portion of the brand-shaped board 100.

### Sixth Embodiment

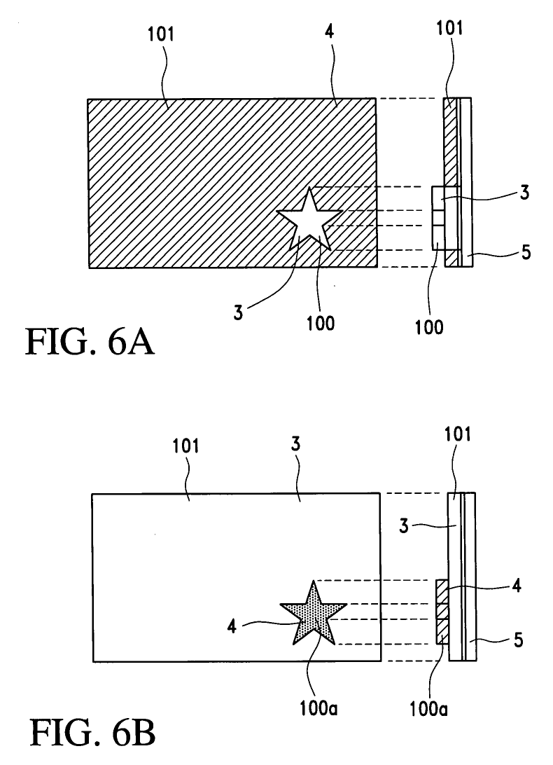

Referring to FIG. 6A, the brand-shaped board 100 is provided at the front surface of the brand billboard 101 and the optical source device 5 is provided at the rear surface of the brand billboard 101.

In this case, the brand-shaped board 100 may be made of the transparent image-display board 3 and the surrounding brand billboard 101 may be made of the opaque colored board 4.

With the present embodiment, if the optical source device 5 provided at the rear surface of the brand billboard 101 produces moving images, the transparent image-display board 3 displays the moving images, thereby allowing the viewer to watch not only the moving images displayed on the transparent image-display board 3, but also the original color and shape of the brand represented by the opaque colored board 4 of the surrounding brand billboard 101.

### Seventh Embodiment

Referring to FIG. 6B, conversely with the configuration shown in FIG. 6A, the brand-shaped board 100 is made of the opaque colored board 4 and the surrounding brand billboard 101 is made of the transparent image-display board 3, such that the opaque colored board 4 shows the original shape of a brand and the transparent image-display board 3 displays a variety of images, so as to more emphasize the shape of the brand.

In one use example, instead of employing the shape of a star as shown in the drawing, the brand-shaped board 100 may have a basketball shoe shape, and the surrounding transparent image-display board 3 may display an image related to basketball.

In another use example, the brand-shaped board 100 may have a car shape, and the surrounding transparent image-display board 3 may display a car traveling image.

In the present embodiment, the transparent image-display board 3 is made of a colored material containing a light-transmittable dye therein. Accordingly, if the optical source device is provided at the rear side of the transparent image-display board 3 to provide the transparent image-display board 3 with an image, the transparent image-display board 3 is able to display the image. Conversely, if no optical source is provided, the transparent image-display board 3 shows the color of the dye. The color of the dye is freely selected according to the use purpose of the transparent image-display board 3.

### Eighth Embodiment

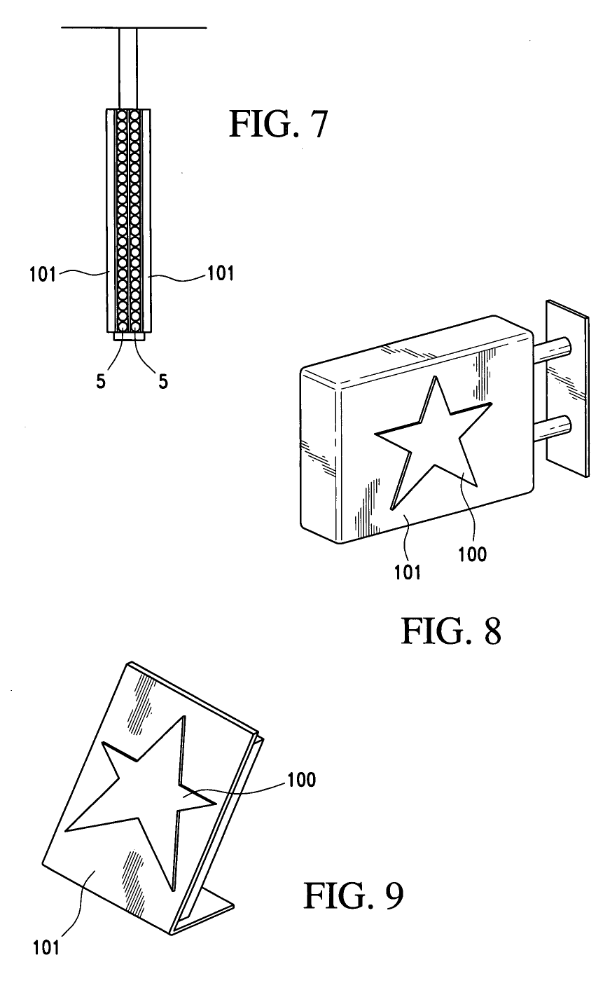

FIG. 7 illustrates a both-sided image-display advertising apparatus in which two brand billboards 101 shown in FIGS. 1 to 3, 5A to 5C, and 6A to 6B are coupled to each other, to form front and rear surfaces of the image-display advertising apparatus. The both-sided image-display advertising apparatus is suitable to be installed to the ceiling of a passageway, so as to allow viewers coming and going through the passageway to watch the image-display advertising apparatus.

### Ninth Embodiment

FIG. 8 illustrates the brand billboard 101 of a wall-rack type constructed by installing the brand billboard 101, shown in FIGS. 1 to 3, 5A to 5C, and 6A to 6B, to a wall surface.

### Tenth Embodiment

FIG. 9 illustrates the brand billboard 101 of a desktop type constructed by installing the brand billboard 101, shown in FIGS. 1 to 3, 5A to 5C, and 6A to 6B, onto a goods display stand or desk of a department store.

### Eleventh Embodiment

Differently from the configuration shown in FIGS. 3 and 6B, both the brand-shaped board 100 and the surrounding brand billboard 101 may be made of the transparent image-display board 3, such that both the brand-shaped board 100 and the brand billboard 101 display different images from the optical source device 5 that is provided at the rear surface of the brand billboard 101.

In this case, the transparent brand-shaped board 100 and the transparent brand billboard 101 have different colored dyes and thus, are able to display different images from each other. Also, when no image is provided thereto, the brand-shaped board 100 and the brand billboard 101 show their original shapes and colors.

As apparent from the above description, the present invention provides an image-display advertising apparatus having the following effects.

Firstly, when a board having the form of a predetermined brand is made of a transparent image-display board, it is possible to maximize the advertising effect of the brand by displaying a variety of images on the brand-shaped board.

Secondly, when the brand-shaped board is made of an opaque colored board and a surrounding board is made of the transparent image-display board, it is possible to simultaneously display the brand shape and a variety of moving images, thereby maximizing the advertising effect of the brand.

Thirdly, when both the brand-shaped board and the surrounding board are made of the transparent image-display boards, the brand-shaped board and the surrounding board can display different images, for example, moving images, from each other. This is efficient to improve the dynamic advertising effect of brands.

Fourthly, according to the present invention, moving images including letters, etc. can be displayed on the brand-shaped board in the form of a brand name, sign, symbol, design, product's shape, etc. in order to allow the shape of the brand look better. This has the effect of improving the image-display advertising effect of the brand.

Fifthly, the brand-shaped board can be used as a brand billboard showing the original shape and color of the brand when no image is provided, and display specific letters or figures provided thereon. Accordingly, the present invention can achieve an epochal effect of selectively displaying the images and the color of dyes contained in the brand-shaped board.

For example, in the daytime, the brand-shaped board is usable as the brand billboard showing the original shape and color of the brand, and in a room or at night, the brand-shaped board may be used as a brand-shaped image-display apparatus displaying a variety of images, such as golden-colored wave pattern, firework display pattern, and the like, thereon.

Accordingly, differently from conventional lettered billboards, the brand-shaped image-display advertising apparatus of the present invention can display a vivid brand-shaped image and be selectively used as a brand billboard.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A brand-shaped image-display advertising apparatus comprising:
a brand-shaped board generally having the shape of a brand name, sign, symbol, or design, or the shape of a product, the brand-shaped board being made of a transparent image-display board; and
an optical source device provided at a rear side of the transparent image-display board and including an imaging screen using a liquid crystal display or light emitting diode, and a projector to project the image on the imaging screen,
wherein the brand-shaped board displays an image thereon.

2. The brand-shaped image-display advertising apparatus according to claim 1, further comprising:
a brand billboard made of an opaque colored board and configured to surround the brand-shaped board,
wherein the brand-shaped board displays the image, whereas the brand billboard shows the color and shape of the selected brand.

3. A brand-shaped image-display advertising apparatus comprising:
a brand billboard made of a transparent image-display board;
a brand-shaped board provided at a surface of the brand billboard and having the shape of a brand name, sign, symbol or design, or the shape of a product, the brand-shaped board being made of an opaque colored board having an original color and shape of a selected brand; and
an optical source device provided at a rear side of the transparent image-display board, the optical source device including an imaging screen using a liquid crystal display or light emitting diode, and a projector to project the image on the imaging screen, wherein
the brand-shaped board shows the original color and shape of the selected brand, and
the image is displayed around the brand-shaped board.

4. The brand-shaped image-display advertising apparatus according to claim 3, wherein both the brand-shaped board and the brand billboard are made of transparent image-display boards.

5. A brand-shaped image-display advertising apparatus comprising:
a brand-shaped board made of a transparent image-display board; and
a projector provided at a rear side of the brand-shaped board,
wherein the brand-shaped board serves to display an image thereon when the projector projects the image onto the brand-shaped board, but shows an original color of a selected brand when the projector projects no image.

6. A brand-shaped image-display advertising apparatus comprising:
a projector having a projection lens, an imaging board located behind the projection lens, a brand-shaped image intercepting film provided at a front side of the imaging board; and
a screen having the same shape as the shape of the image intercepting film.
